(19) United States
(12) Patent Application Publication
(10) Pub. No.: US 2026/0057891 A1
(43) Pub. Date: Feb. 26, 2026

(54) SAME SINGER IDENTIFICATION FOR MUSIC SAMPLES

(71) Applicants: Beijing Zitiao Network Technology Co., Ltd., Beijing (CN); Lemon Inc., Grand Cayman (KY)

(72) Inventors: Jing Jiang, Beijing (CN); Rongrong Liu, Culver City, CA (US)

(21) Appl. No.: 18/810,308

(22) Filed: Aug. 20, 2024

(51) Int. Cl. G10L 17/06; G10L 17/02; G10L 17/18; G10L 21/028; G10L 25/93

(52) U.S. Cl. CPC G10L 17/06; G10L 17/02; G10L 17/18; G10L 21/028; G10L 25/93

(57) ABSTRACT

A computing system including one or more processing devices configured to receive a first music sample and a second music sample. At a music source separation machine learning (ML) model, the one or more processing devices extract a first vocal component from the first music sample and a second vocal component from the second music sample. At a voice embedding ML model, the one or more processing devices extract one or more first embedding vectors from the first vocal component and one or more second embedding vectors from the second vocal component. The one or more processing devices compute a similarity value between the first and second embedding vectors and determine whether the similarity value is above a predefined similarity threshold. Based on the determination, the one or more processing devices output an indication of whether the first music sample has a same singer as the second music sample.

### BACKGROUND

On video sharing platforms, many videos include user-modified music. This music may be modified in a variety of ways, such as by changing a singer or instrumentalist, remixing the music, modifying the rhythm, or modifying the tempo. Some modified music uploaded to a video sharing platform utilizes multiple such techniques concurrently or at different portions of the video.

Music identification is sometimes performed on videos uploaded to a video sharing platform. For example, music identification may be used to identify videos with the same music track. Additionally or alternatively, music identification may be performed to generate a track label that is displayed to a user, such as in a video description header or footer or in an overview of a playlist. However, music identification techniques often fail to correctly determine that two audio samples are the same song, as discussed below, and thus opportunities exist to improve upon current music identification techniques.

### SUMMARY

According to one aspect of the present disclosure, a computing system is provided, including one or more processing devices configured to receive a first music sample and a second music sample. At a music source separation machine learning (ML) model, the one or more processing devices are further configured to extract a first vocal component from the first music sample and a second vocal component from the second music sample. At a voice embedding ML model, the one or more processing devices are further configured to extract one or more first embedding vectors from the first vocal component and one or more second embedding vectors from the second vocal component. The one or more processing devices are further configured to compute a similarity value between the one or more first embedding vectors and the one or more second embedding vectors. The one or more processing devices are further configured to determine whether the similarity value is above a predefined similarity threshold. Based at least in part on the determination of whether the similarity value is above the predefined similarity threshold, the one or more processing devices are further configured to output an indication of whether the first music sample has a same singer as the second music sample.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 schematically shows an example computing system at which vocal cover identification is performed, according to one example embodiment.

FIG. 2 schematically shows a music source separation machine learning model, according to the example of FIG. 1.

FIG. 3 schematically shows a voice embedding machine learning model, according to the example of FIG. 1.

FIG. 4 schematically shows silence removal performed on a first vocal component and a second vocal component, according to the example of FIG. 1.

FIG. 5A schematically shows the computing system when speaker diarization is performed on the first vocal component and the second vocal component, according to the example of FIG. 1.

FIG. 5B schematically shows example vocal components when speaker diarization is performed, according to the example of FIG. 5A.

FIGS. 6A-6C schematically show examples of computation of a similarity value between embedding vectors associated with singer-specific time segments, according to the example of FIG. 5A.

FIG. 7A shows a flowchart of a method for use with a computing system to perform covered song identification, according to the example of FIG. 1.

FIGS. 7B-7D show additional steps of the method of FIG. 7A that may be performed in some examples.

FIG. 8 shows a schematic view of an example computing environment in which the computing system of FIG. 1 may be instantiated.

### DETAILED DESCRIPTION

Videos that include vocal covers of songs are frequently uploaded to video sharing platforms. In order to perform tasks such as music track labeling, music identification may be performed to distinguish between vocal covers and original versions of songs. Previous approaches to vocal cover identification typically compare audio characteristics such as pitch and timbre between pairs of songs. However, when two singers have similar voices, these conventional techniques may be inaccurate.

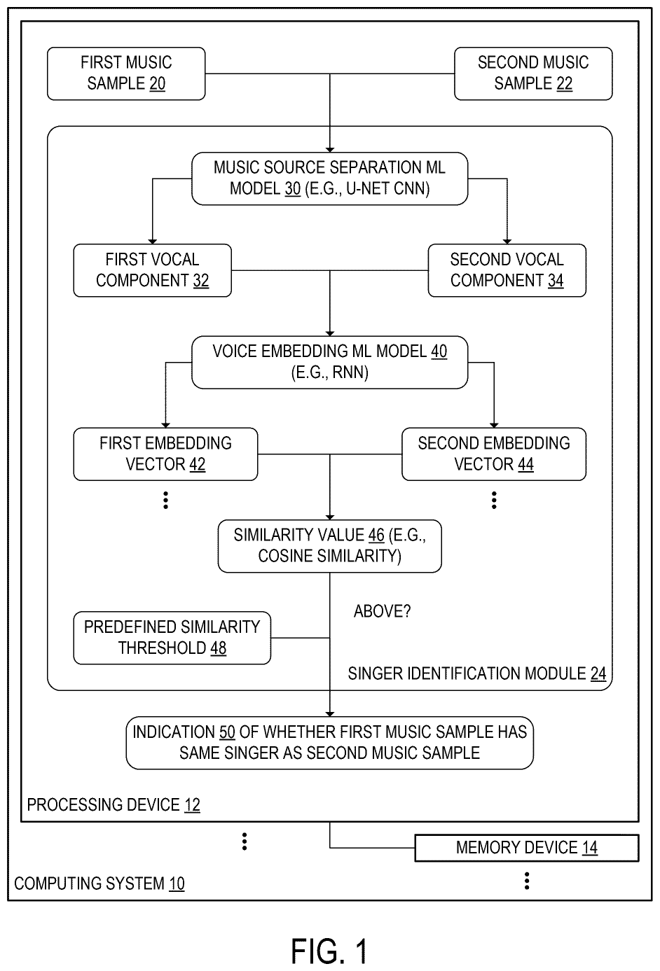

In order to increase the accuracy of vocal cover identification, the following devices and methods are provided. These devices and methods utilize machine learning approaches to determine the level of similarity between two vocal components extracted from audio samples. FIG. 1 schematically shows an example computing system 10 at which vocal cover identification is performed. The computing system 10 includes one or more processing devices 12 and one or more memory devices 14. The one or more processing devices 12 may, for example, include one or more central processing units (CPUs), graphics processing units (GPUs), tensor units, application-specific integrated circuits (ASICs), and/or other types of processing devices 12. The one or more memory devices 14 may include volatile memory and non-volatile storage.

In some examples, the computing system 10 is distributed across a plurality of physical computing devices, whereas in other examples, the one or more processing devices 12 and the one or more memory devices 14 are included in a single physical computing device. In examples in which the computing system 10 is distributed across multiple physical computing devices, those physical computing devices may, for example, include one or more networked computing devices located at a data center. The multiple physical computing devices may additionally or alternatively include one or more client computing devices (e.g., smartphones or desktop computers) that are configured to communicate with one or more server computing devices.

As shown in the example of FIG. 1, the one or more processing devices 12 are configured to receive a first music sample 20 and a second music sample 22. The first music sample 20 and the second music sample 22 are at least partially vocal but may also include additional audio components such as sounds made by other instruments. The additional audio components may additionally or alternatively include background sounds and/or electronically inserted sounds (e.g., backing tracks). The first music sample 20 and/or the second music sample 22 may be an audio component of a video uploaded to the computing system 10 in some examples.

The one or more processing devices 12 are further configured to extract a first vocal component 32 from the first music sample 20 and a second vocal component 34 from the second music sample 22. The first vocal component 32 and the second vocal component 34 are extracted at least in part by executing a music source separation machine learning (ML) model 30. At the music source separation ML model 30, the one or more processing devices 12 are configured to compute separate waveforms associated with different sound sources of the sounds included in the music samples 20 and 22.

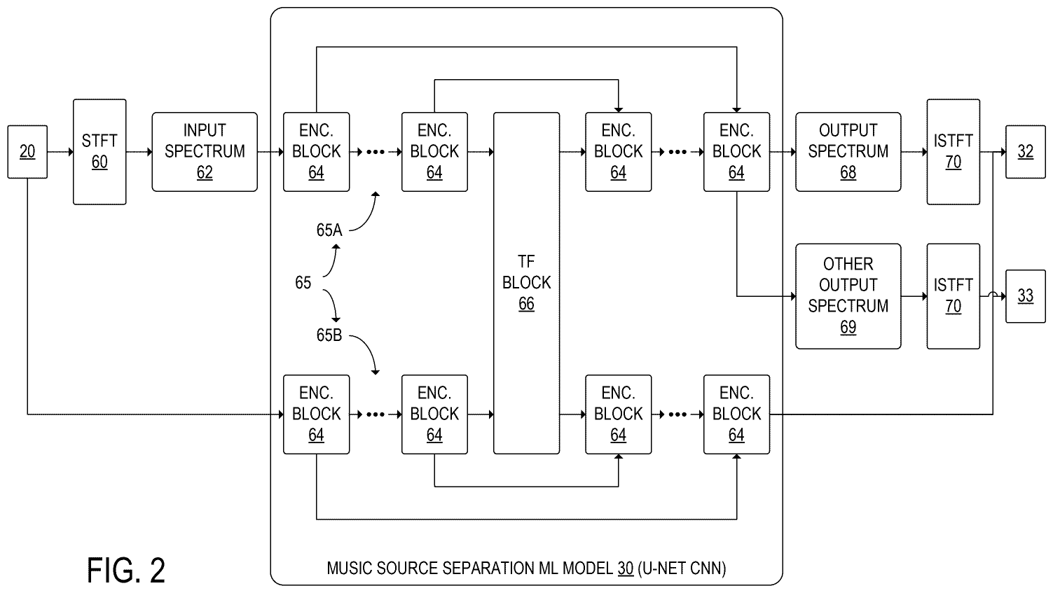

In some examples, the music source separation ML model 30 may be a U-Net convolutional neural network (CNN). The music source separation ML model 30 is schematically depicted in FIG. 2 in an example in which the U-Net CNN architecture is used. In the example of FIG. 2, the music source separation ML model 30 is shown when processing the first music sample 20 to extract the first vocal component 32. The music source separation ML model 30 is further configured to extract an additional sound component 33, which may be a non-vocal component. In some examples, multiple additional sound components 33 corresponding to different non-vocal sounds may be extracted at the music source separation ML model 30.

As shown in the example of FIG. 2, the one or more processing devices 12 are configured to pre-process the first music sample 20 at least in part by performing a short-time Fourier transform (STFT) 60 on the first music sample 20 to extract an input spectrum 62.

The one or more processing devices 12 are further configured to input the first music sample 20 and the input spectrum 62 into respective encoder blocks 64 included in the music source separation ML model 30. In the example of FIG. 2, the encoder blocks 64 are arranged in encoder streams 65 in which upstream encoder blocks 64 are configured to transmit their outputs to downstream encoder blocks 64. The encoder blocks 64 that receive the first music sample 20 and the input spectrum 62 are respectively included in a first encoder stream 65A and a second encoder stream 65B that both feed into a transformer block 66. The transformer block 66 is configured to transmit its outputs to both the first and second encoder streams 65A and 65B. In addition, within each encoder stream 65, the encoder blocks 64 located upstream of the transformer block 66 are each further configured to transmit their outputs to respective encoder blocks 64 located downstream of the transformer block 66 at positions in the encoder stream 65 equidistant from the transformer block 66. Thus, for example, the furthest upstream encoder block 64 in an encoder stream 65 is configured to transmit its outputs to the furthest downstream encoder block 64 in that encoder stream, and the second-furthest upstream encoder block 64 is configured to transmit its outputs to the second-furthest downstream encoder block 64.

In the first encoder stream 65A, the furthest downstream encoder block 64 is further configured to generate an output spectrum 68 of the vocal component 32 and another output spectrum 69 of the additional sound component 33. The one or more processing devices 12 are further configured to perform inverse short-time Fourier transforms (ISTFTs) 70 on the output spectrum 68 and the other output spectrum 69, and to compute the first vocal component 32 and the additional sound component 33 based at least in part on the outputs of the ISTFTs 70. The computation of the first vocal component 32 and the additional sound component 33 is also based at least in part on the output of the furthest downstream encoder block 64 of the second encoder stream 65B. Accordingly, the one or more processing devices 12 are configured to separate different sound sources of the sounds included in the first music sample 20.

Returning to FIG. 1, the one or more processing devices 12 are further configured to execute a voice embedding ML model 40. At the voice embedding ML model 40, the one or more processing devices 12 are configured to extract one or more first embedding vectors 42 from the first vocal component 32 and one or more second embedding vectors 44 from the second vocal component 34. For example, the voice embedding ML model 40 may be a recurrent neural network (RNN), such as a gated recurrent unit (GRU), a long short-term memory (LSTM) network, or a Mamba network. The voice embedding ML model 40 may additionally utilize convolutional structures in some examples, as discussed below.

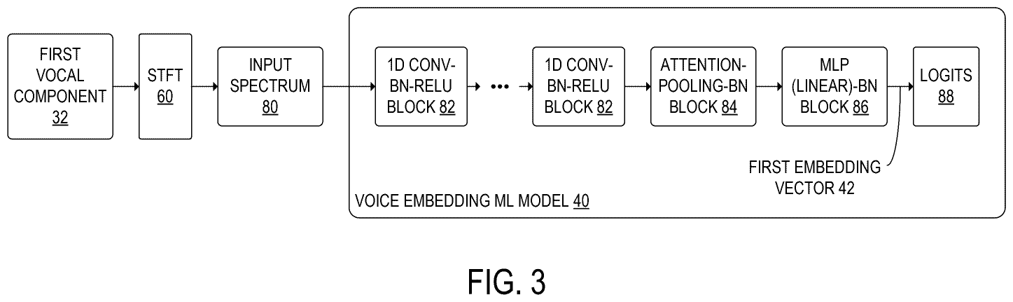

FIG. 3 schematically shows an example architecture of the voice embedding ML model 40. In the example of FIG. 3, the one or more processing devices 12 are configured to pre-process the first vocal component 32 at least in part by performing an STFT 60 to compute an input spectrum 80. The input spectrum 80 is then input into the voice embedding ML model 40. The voice embedding ML model 40 includes a plurality of 1-dimensional (1D) conv-BN-ReLU blocks 82 that are each configured to perform 1-dimensional convolution, batch normalization (BN), and a rectified linear unit (ReLU) function on their inputs.

Downstream from the plurality of 1D conv-BN-ReLU blocks 82, the voice embedding ML model 40 shown in the example of FIG. 3 further includes an attention pooling-BN block 84 at which the one or more processing devices 12 are further configured to perform attention pooling and batch normalization. Downstream from the attention pooling-BN block 84, the voice embedding ML model 40 further includes an MLP-BN block 86. At the MFP-BN block 86, the one or more processing devices 12 are further configured to execute one or more multi-layer perceptron (MLP) layers (also referred to as linear layers) and perform batch normalization.

The first embedding vector 42 is computed as an output of the MLP-BN block 86 in the example of FIG. 3. In addition, the one or more processing devices 12 are further configured to compute logits 88 based at least in part on the first embedding vector 42. The logits 88 may, for example, be used during training of the voice embedding ML model 40. The one or more processing devices 12 may be configured to skip computation of the logits 88 during inferencing time.

Returning to the example of FIG. 1, the one or more processing devices 12 are further configured to compute a similarity value 46 between the one or more first embedding vectors 42 and the one or more second embedding vectors 44. For example, the one or more processing devices 12 may be configured to compute the similarity value 46 as a cosine similarity. In some examples, as discussed in further detail below, multiple different similarity values corresponding to different time segments of the first vocal component 32 and the second vocal component 34 may be computed and may be further used to compute the similarity value 46.

The one or more processing devices 12 are further configured to determine whether the similarity value 46 is above a predefined similarity threshold 48. Based at least in part on the determination of whether the similarity value 46 is above the predefined similarity threshold 48, the one or more processing devices 12 are further configured to output an indication 50 of whether the first music sample 20 has a same singer as the second music sample 22. The one or more processing devices 12 are accordingly configured to use the similarity value 46 to perform vocal cover identification.

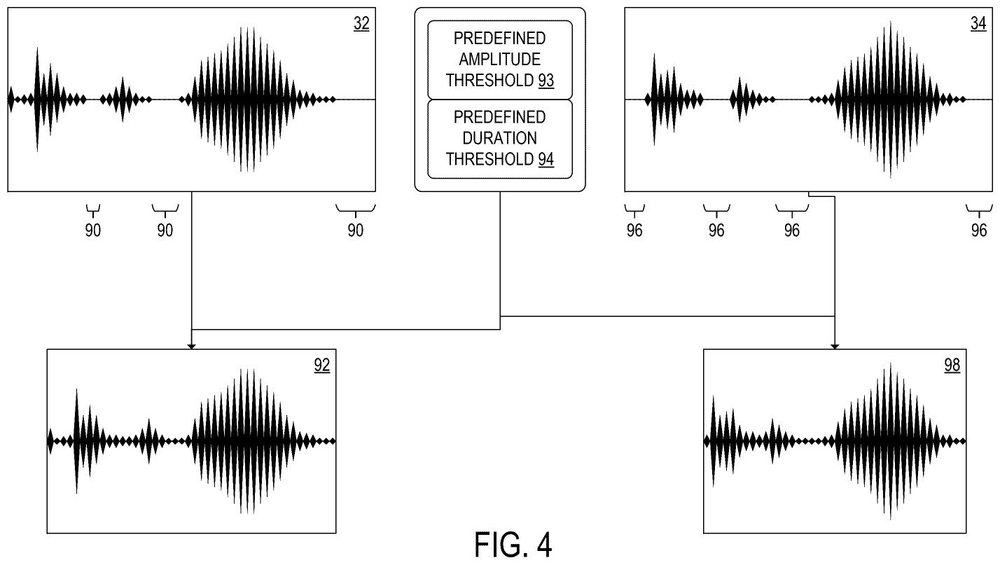

In some examples, as shown in FIG. 4, the one or more processing devices 12 may be further configured to perform silence removal on the first vocal component 32 and the second vocal component 34 prior to extracting the one or more first embedding vectors 42 and the one or more second embedding vectors 44. Performing the silence removal may include identifying one or more silence time segments in each of the first vocal component 32 and the second vocal component 34. The first vocal component 32 includes silence time segments 90 and the second vocal component 34 includes silence time segments 96 in the example of FIG. 4. The silence time segments 90 and 96 are time segments in which an amplitude of the corresponding vocal component is below a predefined amplitude threshold 93 for a duration longer than a predefined duration threshold 94. Thus, the one or more processing devices 12 may be configured to distinguish the silence time segments 90 and 96 from smaller decreases in the amplitude, and from decreases in the amplitude that have shorter durations.

The silence removal further includes removing the one or more silence time segments 90 and 96 from the first vocal component 32 and the second vocal component 34, respectively. The one or more processing devices 12 are accordingly configured to obtain a first silence-removed vocal component 92 and a second silence-removed vocal component 98.

FIG. 4A schematically shows the computing system 10 in an example in which the one or more processing devices 12 are further configured to perform speaker diarization prior to extracting the one or more first embedding vectors 42 and the one or more second embedding vectors 44. The example of FIG. 4A shows the one or more processing devices 12 performing speaker diarization on the first vocal component 32 and the second vocal component 34. Alternatively, the one or more processing devices 12 may be configured to perform speaker diarization on the first silence-removed vocal component 92 and the second silence-removed vocal component 98.

In the example of FIG. 4A, performing speaker diarization includes identifying a plurality of first singer-specific time segments 102 included in the first vocal component 32 and a plurality of second singer-specific time segments 106 included in the second vocal component 34. The first singer-specific time segments 102 are labeled as having been sung by respective singers 104, and the second singer-specific time segments 106 are labeled as having been sung by respective singers 108.

In the example of FIG. 4A, the one or more processing devices 12 are configured to perform speaker diarization at least in part using a speaker diarization ML model 100. The speaker diarization ML model 100 is trained to classify time segments of audio inputs according to whether those time segments have a same singer as time segments occurring earlier in the audio input.

Subsequently to performing speaker diarization, the one or more processing devices 12 may be further configured to compute a respective plurality of similarity values 46 between the first singer-specific time segments 102 and the second singer-specific time segments 106. For each of the similarity values 46, the one or more processing devices 12 may be further configured to determine whether that similarity value 46 is above the predefined similarity threshold 48. The one or more processing devices 12 may be further configured to output the indication 50 of whether the first music sample 20 has the same singer as the second music sample 22 based at least in part on the determinations of whether the similarity values 46 are above the predefined similarity threshold 48. For example, the one or more processing devices 12 may be configured to indicate the first music sample 20 and the second music sample 22 as having the same singer if any of the similarity values 46 are above the predefined similarity threshold 48. In some examples, the one or more processing devices 12 may determine that two or more of the singers are the same between the first music sample 20 and the second music sample 22.

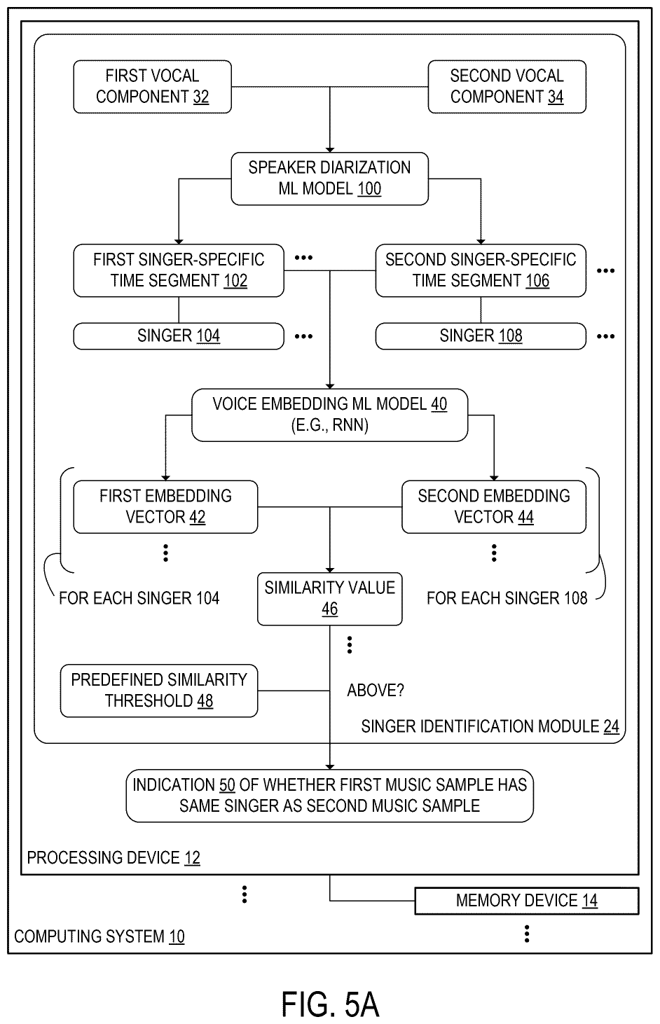

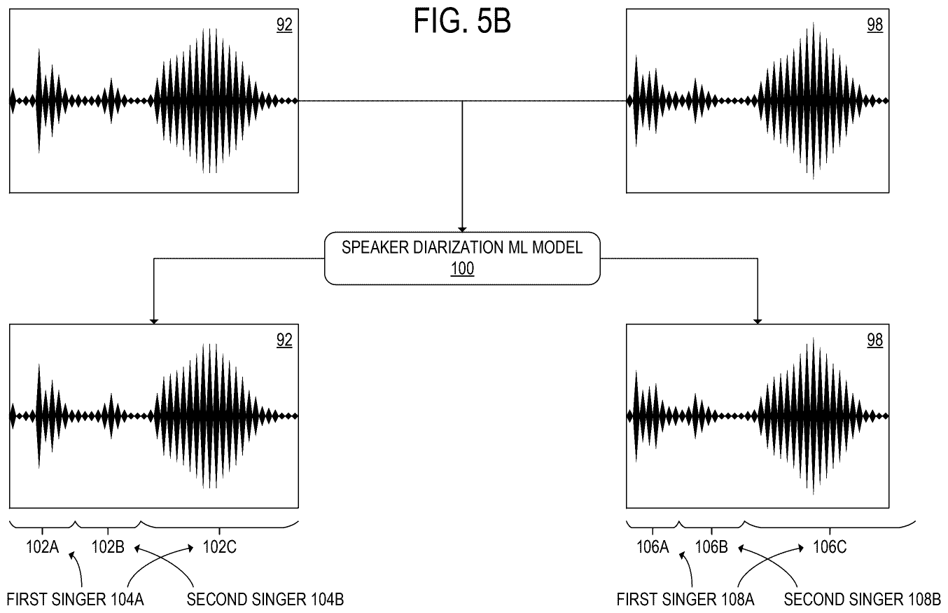

FIG. 5B schematically shows an example in which speaker diarization is performed on a first silence-removed vocal component 92 and a second silence-removed vocal component 98. In this example, the speaker diarization ML model 100 divides the first silence-removed vocal component 92 into first singer-specific time segments 102A, 102B, and 102C. The speaker diarization ML model 100 also labels the first singer-specific time segments 102A and 102C as having been sung by a first singer 104A and labels the first singer-specific time segment 102B as having been sung by a second singer 104B. In addition, the speaker diarization ML model 100 divides the second silence-removed vocal component 98 into second singer-specific time segments 106A, 106B, and 106C. The speaker diarization ML model 100 labels the second singer-specific time segments 106A and 106C as having been sung by a first singer 108A and labels the second singer-specific time segment 106B as having been sung by a second singer 108B.

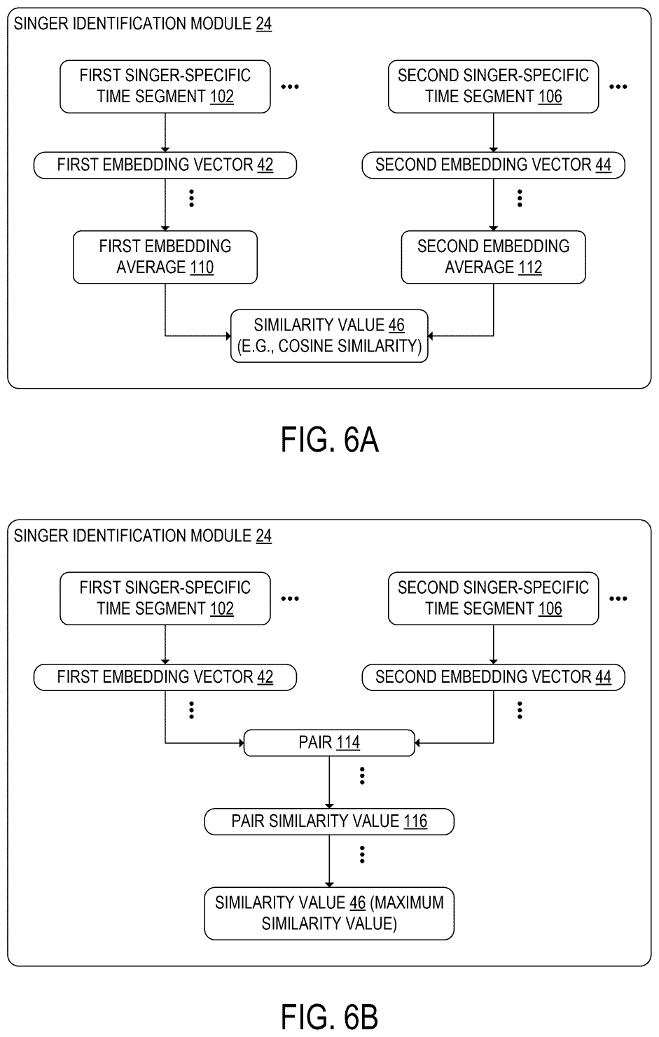

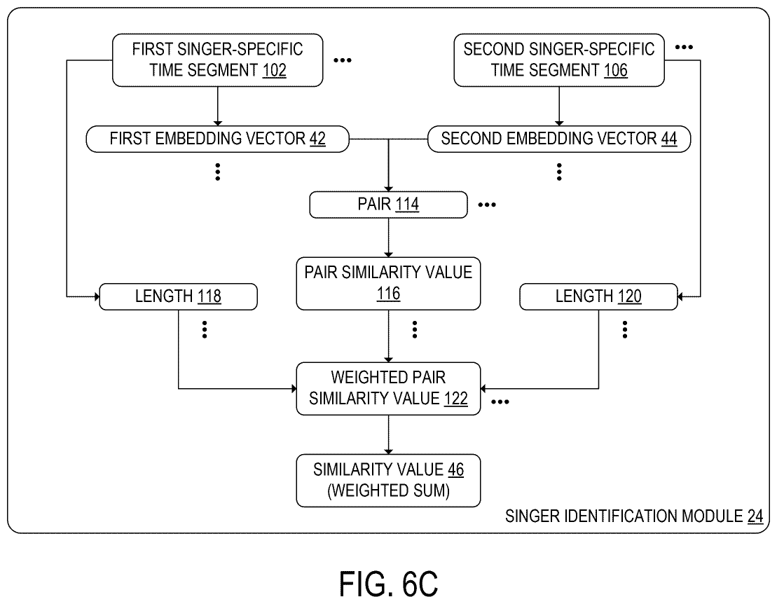

FIGS. 6A-6C schematically show example approaches to similarity value computation that may be used in examples in which speaker diarization is performed. In the examples of FIGS. 6A-6C, the one or more processing devices 12 are configured to compute respective similarity values 46 that are aggregated across the sets of singer-specific time segments 102 and 106.

In the example of FIG. 6A, the one or more processing devices 12 are configured to compute a plurality of first embedding vectors 42 respectively associated with a plurality of first time segments (the first singer-specific time segments 102, in the example of FIG. 6A) included in the first vocal component 32. The one or more processing devices 12 are further configured to compute a plurality of second embedding vectors 44 respectively associated with a plurality of second time segments (the second singer-specific time segments 106, in the example of FIG. 6A) included in the second vocal component 34. The one or more processing devices 12 are further configured to compute a first embedding average 110 of the first embedding vectors 42 and a second embedding average 112 of the second embedding vectors 44, and to compute the similarity value 46 as a similarity between the first embedding average 110 and the second embedding average 112. Thus, the similarity value 46 is an estimate of average similarity between the first vocal component 32 and the second vocal component 34.

FIG. 6B schematically shows another example in which the one or more processing devices are configured to compute a plurality of first embedding vectors 42 and a plurality of second embedding vectors 44, as in the example of FIG. 6A. In the example of FIG. 6B, the one or more processing devices 12 are further configured to compute respective pair similarity values 116 for a plurality of pairs 114 that each include a respective first embedding vector 42 and a respective second embedding vector 44. In some examples, the one or more processing devices 12 are configured to compute respective pair similarity values 116 for each possible pair 114 of a first embedding vector 42 and a second embedding vector 44 among the plurality of first embedding vectors 42 and second embedding vectors 44 computed at the voice embedding ML model 40. In the example of FIG. 6B, the one or more processing devices 12 are further configured to compute the similarity value 46 as a maximum similarity value among the pair similarity values 116.

In the example of FIG. 6C, the one or more processing devices 12 are configured to compute a plurality of first embedding vectors 42 and a plurality of second embedding vectors 44, as in the example of FIGS. 6A-6B. The one or more processing devices 12 are further configured to compute a plurality of pairs 114 of embedding vectors and pair similarity values 116 of those pairs 114, as in the example of FIG. 6B. The one or more processing devices 12 are further configured to compute a plurality of weighted pair similarity values 122 based at least in part on the pair similarity values 116.

In the example of FIG. 6C, the weighted pair similarity value 122 of a pair 114 is weighted according to the respective lengths 118 and 120 of the first singer-specific time segment 102 and the second singer-specific time segment 104 used to generate the first embedding vector 42 and second embedding vector 44 included in the pair 114. For example, the following equation may be used to compute the weighted pair similarity value:

$$Global similarity = {\sum }_{i} \frac{length ( {a}_{i} ) * length ( {b}_{i} ) * similarity ( {a}_{i} , {b}_{i} )}{length ( {a}_{i} ) + length ( {b}_{i} )}$$

In the above equation, aᵢ and bᵢ are the first embedding vector 42 and the second embedding vector 44 included in the pair 114. Thus, the one or more processing devices 12 are configured to compute the similarity value 46 as a weighted sum over the respective pair similarity values 116. By weighting the pair similarity values 116 according to the lengths 118 and 120 of the first and second singer-specific time segments 102 and 104, the one or more processing devices 12 are configured to base the computation of the similarity value 46 more heavily on singer-specific time segments that provide larger samples for the similarity determination.

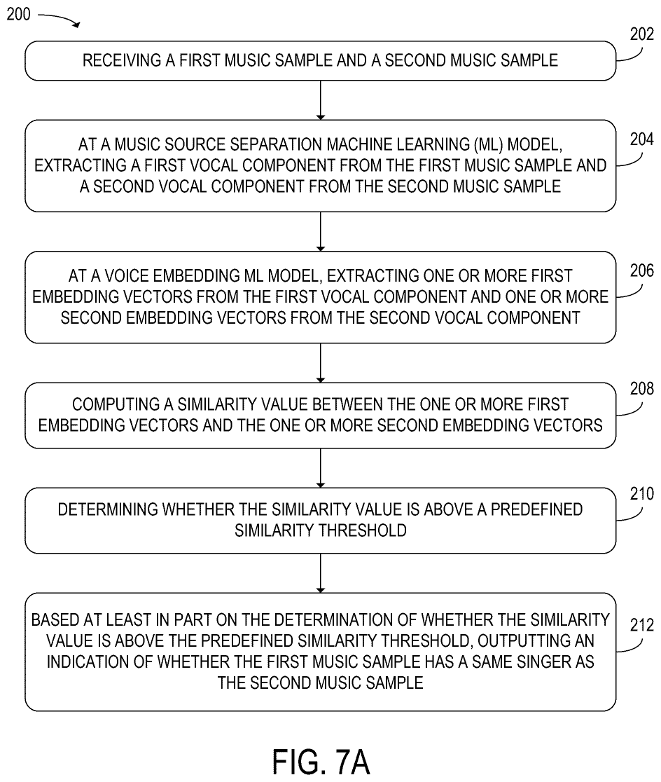

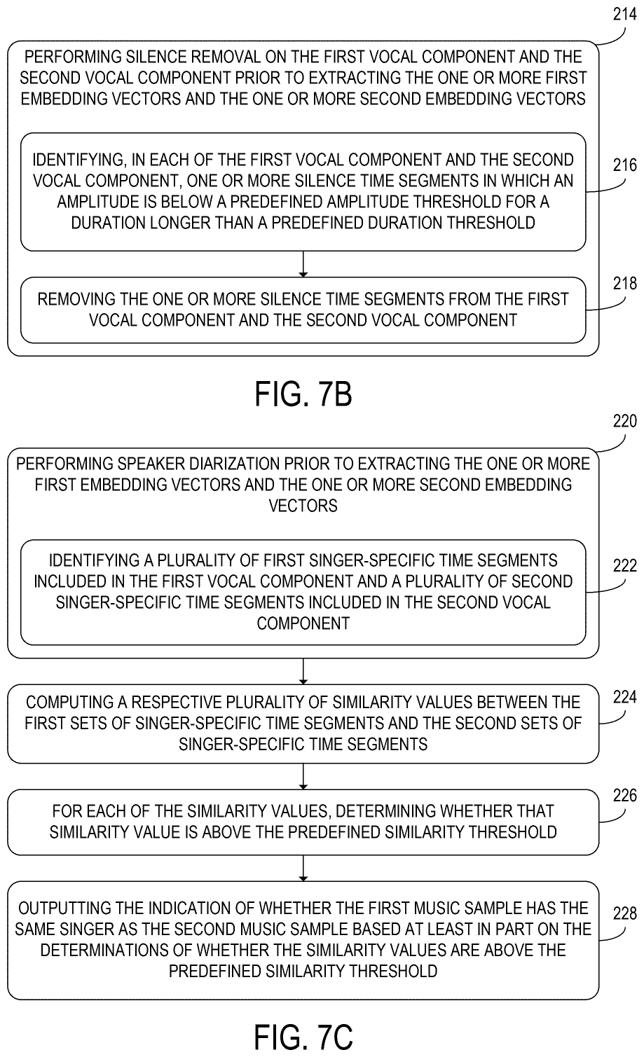

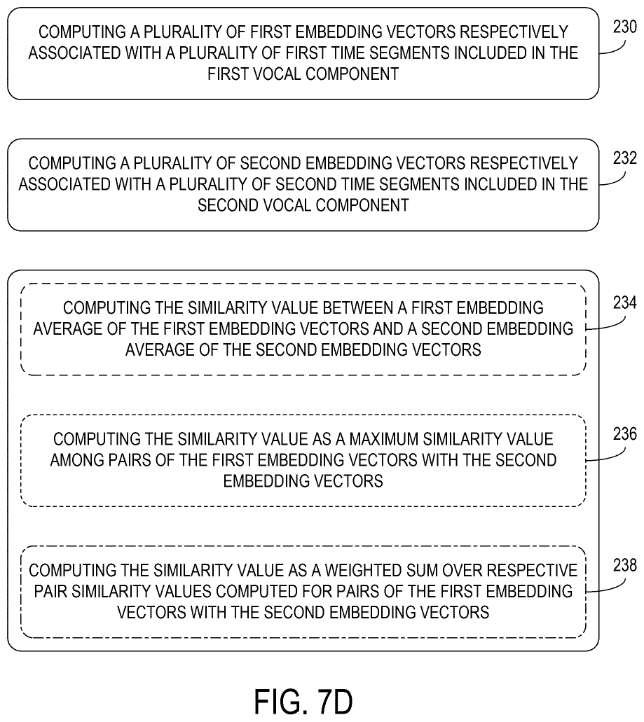

FIG. 7A shows a flowchart of a method 200 for use with a computing system to perform covered song identification. At step 202, the method 200 includes receiving a first music sample and a second music sample.

At step 204, the method 200 further includes extracting a first vocal component from the first music sample and a second vocal component from the second music sample. The first vocal component and the second vocal component are extracted at a music source separation ML model, which may, for example, be a U-Net CNN. In other examples, some other architecture may be used for the music source separation ML model. The first vocal component and the second vocal component are respective vocal contributions to the waveforms of the first music sample and the second music sample, respectively.

At step 206, the method 200 further includes extracting one or more first embedding vectors from the first vocal component and one or more second embedding vectors from the second vocal component. The one or more first embedding vectors and the one or more second embedding vectors are extracted at a voice embedding ML model. The voice embedding ML model may be an RNN, such as a GRU, LSTM, or Mamba network.

At step 208, the method 200 further includes computing a similarity value between the one or more first embedding vectors and the one or more second embedding vectors. In addition, at step 210, the method 200 further includes determining whether the similarity value is above a predefined similarity threshold. Based at least in part on the determination of whether the similarity value is above the predefined similarity threshold, the method 200 further includes, at step 212, outputting an indication of whether the first music sample has a same singer as the second music sample. The computing system may accordingly output an indication that the first music sample has the same singer as the second music sample in response to determining that the similarity value is above the predefined similarity threshold and may output an indication that the music samples have different singers in response to determining that the similarity value is below the predefined similarity threshold.

FIGS. 7B-7D show additional steps of the method 200 of FIG. 7A that may be performed in some examples. The example of FIG. 7B shows additional steps that may be performed prior to extracting the one or more first embedding vectors and the one or more second embedding vectors from the first vocal component and the second vocal component. At step 214, the method 200 may further include performing silence removal on the first vocal component and the second vocal component. Performing silence removal at step 214 may include, at step 216, identifying one or more silence time segments in each of the first vocal component and the second vocal component. The silence time segments may be time segments in which an amplitude is below a predefined amplitude threshold for a duration longer than a predefined duration threshold. At step 218, performing the silence removal may further include removing the one or more silence time segments from the first vocal component and the second vocal component.

FIG. 7C shows steps of the method 200 that may be performed prior to extracting the first one or more embedding vectors and the one or more second embedding vectors, additionally or alternatively to the steps of FIG. 7B. At step 220, the method 200 may further include performing speaker diarization on the first vocal component and the second vocal component. Performing speaker diarization may include, at step 222, identifying a plurality of first singer-specific time segments included in the first vocal component and a plurality of second singer-specific time segments included in the second vocal component.

In some examples, at step 224, the method 200 may further include computing a respective plurality of similarity values between the first singer-specific time segments and the second singer-specific time segments. At step 226, for each of the similarity values, the method 200 may further include determining whether that similarity value is above the predefined similarity threshold. At step 228, the method 200 may further include outputting the indication of whether the first music sample has the same singer as the second music sample based at least in part on the determinations of whether the similarity values are above the predefined similarity threshold. In some examples, separate indications may be output for the different singer-specific time segments. Thus, for example, the computing system may indicate that a first singer is the same between the first music sample and the second music sample, but a second singer is different.

FIG. 7D shows additional steps that may be performed in some examples to compute the similarity value. At step 230, the method 200 may further include computing a plurality of first embedding vectors respectively associated with a plurality of first time segments included in the first vocal component. In addition, at step 232, the method 200 may further include computing a plurality of second embedding vectors respectively associated with a plurality of second time segments included in the second vocal component. The first embedding vectors and the second embedding vectors may be computed at the voice embedding ML model based at least in part on the first singer-specific time segments and the second singer-specific time segments, respectively.

In some examples, at step 234, the method 200 may further include computing the similarity value between a first embedding average of the first embedding vectors and a second embedding average of the second embedding vectors. In other examples, at step 236, the method 200 may further include computing the similarity value as a maximum similarity value among pairs of the first embedding vectors with the second embedding vectors. Alternatively, at step 238, the method 200 may further include computing the similarity value as a weighted sum over respective pair similarity values computed for pairs of the first embedding vectors with the second embedding vectors. The pair similarity values may, for example, be weighted according to the lengths of the time segments from which the first and second embedding vectors included in the pair are computed.

Using the devices and methods discussed above, cover detection may be performed for pairs of music samples. By determining whether a first music sample has the same singer as a second music sample, more accurate labels associated with the samples may be presented to users of a video uploading platform.

The methods and processes described herein are tied to a computing system of one or more computing devices. In particular, such methods and processes can be implemented as a computer-application program or service, an application-programming interface (API), a library, and/or other computer-program product.

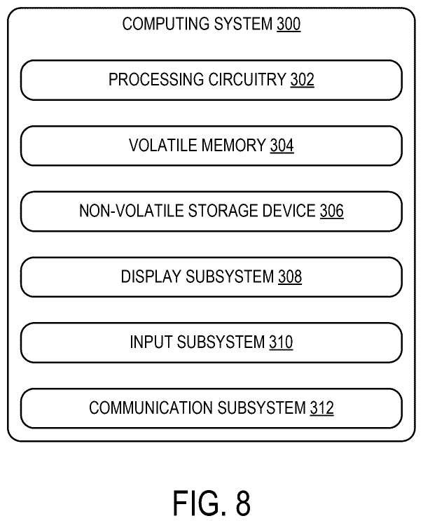

FIG. 8 schematically shows a non-limiting embodiment of a computing system 300 that can enact one or more of the methods and processes described above. Computing system 300 is shown in simplified form. Computing system 300 may embody the computing system 10 described above and illustrated in FIG. 1. Components of computing system 300 may be included in one or more personal computers, server computers, tablet computers, home-entertainment computers, network computing devices, video game devices, mobile computing devices, mobile communication devices (e.g., smartphone), and/or other computing devices, and wearable computing devices such as smart wristwatches and head mounted augmented reality devices.

Computing system 300 includes processing circuitry 302, volatile memory 304, and a non-volatile storage device 306. Computing system 300 may optionally include a display subsystem 308, input subsystem 310, communication subsystem 312, and/or other components not shown in FIG. 8.

Processing circuitry 302 typically includes one or more logic processors, which are physical devices configured to execute instructions. For example, the logic processors may be configured to execute instructions that are part of one or more applications, programs, routines, libraries, objects, components, data structures, or other logical constructs. Such instructions may be implemented to perform a task, implement a data type, transform the state of one or more components, achieve a technical effect, or otherwise arrive at a desired result.

The logic processor may include one or more physical processors configured to execute software instructions. Additionally or alternatively, the logic processor may include one or more hardware logic circuits or firmware devices configured to execute hardware-implemented logic or firmware instructions. Processors of the processing circuitry 302 may be single-core or multi-core, and the instructions executed thereon may be configured for sequential, parallel, and/or distributed processing. Individual components of the processing circuitry 302 optionally may be distributed among two or more separate devices, which may be remotely located and/or configured for coordinated processing. For example, aspects of the computing system 300 disclosed herein may be virtualized and executed by remotely accessible, networked computing devices configured in a cloud-computing configuration. In such a case, these virtualized aspects are run on different physical logic processors of various different machines. These different physical logic processors of the different machines will be understood to be collectively encompassed by processing circuitry 302.

Non-volatile storage device 306 includes one or more physical devices configured to hold instructions executable by the processing circuitry 302 to implement the methods and processes described herein. When such methods and processes are implemented, the state of non-volatile storage device 306 may be transformed—e.g., to hold different data.

Non-volatile storage device 306 may include physical devices that are removable and/or built in. Non-volatile storage device 306 may include optical memory, semiconductor memory, and/or magnetic memory, or other mass storage device technology. Non-volatile storage device 306 may include nonvolatile, dynamic, static, read/write, read-only, sequential-access, location-addressable, file-addressable, and/or content-addressable devices. It will be appreciated that non-volatile storage device 306 is configured to hold instructions even when power is cut to the non-volatile storage device 306.

Volatile memory 304 may include physical devices that include random access memory. Volatile memory 304 is typically utilized by processing circuitry 302 to temporarily store information during processing of software instructions. It will be appreciated that volatile memory 304 typically does not continue to store instructions when power is cut to the volatile memory 304.

Aspects of processing circuitry 302, volatile memory 304, and non-volatile storage device 306 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

The terms “module,” “program,” and “engine” may be used to describe an aspect of computing system 300 typically implemented in software by a processor to perform a particular function using portions of volatile memory, which function involves transformative processing that specially configures the processor to perform the function. Thus, a module, program, or engine may be instantiated via processing circuitry 302 executing instructions held by non-volatile storage device 306, using portions of volatile memory 304. It will be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” may encompass individual or groups of executable files, data files, libraries, drivers, scripts, database records, etc.

When included, display subsystem 308 may be used to present a visual representation of data held by non-volatile storage device 306. The visual representation may take the form of a graphical user interface (GUI). As the herein described methods and processes change the data held by the non-volatile storage device, and thus transform the state of the non-volatile storage device, the state of display subsystem 308 may likewise be transformed to visually represent changes in the underlying data. Display subsystem 308 may include one or more display devices utilizing virtually any type of technology. Such display devices may be combined with processing circuitry 302, volatile memory 304, and/or non-volatile storage device 306 in a shared enclosure, or such display devices may be peripheral display devices.

When included, input subsystem 310 may comprise or interface with one or more user-input devices such as a keyboard, mouse, touch screen, camera, or microphone.

When included, communication subsystem 312 may be configured to communicatively couple various computing devices described herein with each other, and with other devices. Communication subsystem 312 may include wired and/or wireless communication devices compatible with one or more different communication protocols. As non-limiting examples, the communication subsystem 312 may be configured for communication via a wired or wireless local- or wide-area network, broadband cellular network, etc. In some embodiments, the communication subsystem may allow computing system 300 to send and/or receive messages to and/or from other devices via a network such as the Internet.

The following paragraphs provide additional description of the subject matter of the present disclosure. According to one aspect of the present disclosure, a computing system is provided, including one or more processing devices configured to receive a first music sample and a second music sample. At a music source separation machine learning (ML) model, the one or more processing devices are further configured to extract a first vocal component from the first music sample and a second vocal component from the second music sample. At a voice embedding ML model, the one or more processing devices are further configured to extract one or more first embedding vectors from the first vocal component and one or more second embedding vectors from the second vocal component. The one or more processing devices are further configured to compute a similarity value between the one or more first embedding vectors and the one or more second embedding vectors. The one or more processing devices are further configured to determine whether the similarity value is above a predefined similarity threshold. Based at least in part on the determination of whether the similarity value is above the predefined similarity threshold, the one or more processing devices are further configured to output an indication of whether the first music sample has a same singer as the second music sample. The above features may have the technical effect of labeling the first and second music samples according to whether they have the same singer or different singers.

According to this aspect, the one or more processing devices are further configured to perform silence removal on the first vocal component and the second vocal component prior to extracting the one or more first embedding vectors and the one or more second embedding vectors. The above features may have the technical effect of filtering out portions of the first vocal component and the second vocal component that are irrelevant to singer identification.

According to this aspect, performing the silence removal may include identifying, in each of the first vocal component and the second vocal component, one or more silence time segments in which an amplitude is below a predefined amplitude threshold for a duration longer than a predefined duration threshold. Performing the silence removal may further include removing the one or more silence time segments from the first vocal component and the second vocal component. The above features may have the technical effect of performing silence removal on the vocal components.

According to this aspect, the one or more processing devices may be further configured to perform speaker diarization prior to extracting the one or more first embedding vectors and the one or more second embedding vectors. Performing speaker diarization may include identifying a plurality of first singer-specific time segments included in the first vocal component and a plurality of second singer-specific time segments included in the second vocal component. The above features may have the technical effect of distinguishing between singers when the first and second vocal components both have multiple different singers.

According to this aspect, the one or more processing devices may be further configured to compute a respective plurality of similarity values between the first singer-specific time segments and the second singer-specific time segments. For each of the similarity values, the one or more processing devices may be further configured to determine whether that similarity value is above the predefined similarity threshold. The one or more processing devices may be further configured to output the indication of whether the first music sample has the same singer as the second music sample based at least in part on the determinations of whether the similarity values are above the predefined similarity threshold. The above features may have the technical effect of performing singer comparison for each of the singers in a pair of multi-singer music samples.

According to this aspect, the one or more processing devices may be configured to perform the speaker diarization at least in part using a speaker diarization ML model. The above feature may have the technical effect of identifying the singer-specific time segments.

According to this aspect, the one or more processing devices may be configured to compute the similarity value as a cosine similarity. The above feature may have the technical effect of determining an amount of similarity between the first embedding vectors and the second embedding vectors.

According to this aspect, the one or more processing devices may be further configured to compute a plurality of first embedding vectors respectively associated with a plurality of first time segments included in the first vocal component. The one or more processing devices may be further configured to compute a plurality of second embedding vectors respectively associated with a plurality of second time segments included in the second vocal component. The one or more processing devices may be further configured to compute the similarity value between a first embedding average of the first embedding vectors and a second embedding average of the second embedding vectors. The above features may have the technical effect of computing an average similarity between the first and second vocal components.

According to this aspect, the one or more processing devices may be further configured to compute a plurality of first embedding vectors respectively associated with a plurality of first time segments included in the first vocal component. The one or more processing devices may be further configured to compute a plurality of second embedding vectors respectively associated with a plurality of second time segments included in the second vocal component. The one or more processing devices may be further configured to compute the similarity value as a maximum similarity value among pairs of the first embedding vectors with the second embedding vectors. The above features may have the technical effect of identifying the pair of time segments with the highest similarity between the first vocal component and the second vocal component.

According to this aspect, the one or more processing devices may be further configured to compute a plurality of first embedding vectors respectively associated with a plurality of first time segments included in the first vocal component. The one or more processing devices may be further configured to compute a plurality of second embedding vectors respectively associated with a plurality of second time segments included in the second vocal component. The one or more processing devices may be further configured to compute the similarity value as a weighted sum over respective pair similarity values computed for pairs of the first embedding vectors with the second embedding vectors. The above features may have the technical effect of computing the similarity value as a weighted sum, where the time segments may, for example, be weighted by length.

According to this aspect, the music source separation ML model may be a U-Net convolutional neural network (CNN). The above feature may have the technical effect of separating the vocal components from non-vocal components of the music samples.

According to this aspect, the voice embedding ML model is a recurrent neural network (RNN). The above feature may have the technical effect of computing the embedding vectors from the vocal components.

According to another aspect of the present disclosure, a method for use with a computing system is provided. The method includes receiving a first music sample and a second music sample. The method further includes, at a music source separation machine learning (ML) model, extracting a first vocal component from the first music sample and a second vocal component from the second music sample. The method further includes, at a voice embedding ML model, extracting one or more first embedding vectors from the first vocal component and one or more second embedding vectors from the second vocal component. The method further includes computing a similarity value between the one or more first embedding vectors and the one or more second embedding vectors. The method further includes determining whether the similarity value is above a predefined similarity threshold. The method further includes, based at least in part on the determination of whether the similarity value is above the predefined similarity threshold, outputting an indication of whether the first music sample has a same singer as the second music sample. The above features may have the technical effect of labeling the first and second music samples according to whether they have the same singer or different singers.

According to this aspect, the method further includes performing silence removal on the first vocal component and the second vocal component prior to extracting the one or more first embedding vectors and the one or more second embedding vectors. The above features may have the technical effect of filtering out portions of the first vocal component and the second vocal component that are irrelevant to singer identification.

According to this aspect, performing the silence removal may include identifying, in each of the first vocal component and the second vocal component, one or more silence time segments in which an amplitude is below a predefined amplitude threshold for a duration longer than a predefined duration threshold. Performing the silence removal may further include removing the one or more silence time segments from the first vocal component and the second vocal component. The above features may have the technical effect of performing silence removal on the vocal components.

According to this aspect, the method may further include performing speaker diarization prior to extracting the one or more first embedding vectors and the one or more second embedding vectors. Performing speaker diarization may include identifying a plurality of first singer-specific time segments included in the first vocal component and a plurality of second singer-specific time segments included in the second vocal component. The above features may have the technical effect of distinguishing between singers when the first and second vocal components both have multiple different singers.

According to this aspect, the method may further include computing a respective plurality of similarity values between the first singer-specific time segments and the second singer-specific time segments. The method may further include, for each of the similarity values, determining whether that similarity value is above the predefined similarity threshold. The method may further include outputting the indication of whether the first music sample has the same singer as the second music sample based at least in part on the determinations of whether the similarity values are above the predefined similarity threshold. The above features may have the technical effect of performing singer comparison for each of the singers in a pair of multi-singer music samples.

According to this aspect, the music source separation ML model may be a U-Net convolutional neural network (CNN). The above feature may have the technical effect of separating the vocal components from non-vocal components of the music samples.

According to this aspect, the voice embedding ML model may be a recurrent neural network (RNN). The above feature may have the technical effect of computing the embedding vectors from the vocal components.

According to another aspect of the present disclosure, a computing system is provided, including one or more processing devices configured to receive a first music sample and a second music sample. At a music source separation machine learning (ML) model, the one or more processing devices are further configured to extract a first vocal component from the first music sample and a second vocal component from the second music sample. The one or more processing devices are further configured to perform speaker diarization on the first vocal component and the second vocal component to thereby identify a plurality of first singer-specific time segments included in the first vocal component and a plurality of second singer-specific time segments included in the second vocal component. At a voice embedding ML model, for each of the first singer-specific time segments, the one or more processing devices are further configured to extract a corresponding first embedding vector from the first vocal component, and, for each of the second singer-specific time segments, extract a corresponding second embedding vector from the second vocal component. The one or more processing devices are further configured to compute a respective plurality of similarity values between the first sets of singer-specific time segments and the second sets of singer-specific time segments. For each of the similarity values, the one or more processing devices are further configured to determine whether that similarity value is above the predefined similarity threshold. The one or more processing devices are further configured to output the indication of whether the first music sample has the same singer as the second music sample based at least in part on the determinations of whether the similarity values are above the predefined similarity threshold. The above features may have the technical effect of labeling the first and second music samples according to whether they have the same singer or different singers.

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. A computing system comprising:
one or more processing devices configured to:
receive a first music sample and a second music sample;
at a music source separation machine learning (ML) model, extract a first vocal component from the first music sample and a second vocal component from the second music sample;
at a voice embedding ML model, extract one or more first embedding vectors from the first vocal component and one or more second embedding vectors from the second vocal component;
compute a similarity value between the one or more first embedding vectors and the one or more second embedding vectors;
determine whether the similarity value is above a predefined similarity threshold; and
based at least in part on the determination of whether the similarity value is above the predefined similarity threshold, output an indication of whether the first music sample has a same singer as the second music sample.

2. The computing system of claim 1, wherein the one or more processing devices are further configured to perform silence removal on the first vocal component and the second vocal component prior to extracting the one or more first embedding vectors and the one or more second embedding vectors.

3. The computing system of claim 2, wherein performing the silence removal includes:
identifying, in each of the first vocal component and the second vocal component, one or more silence time segments in which an amplitude is below a predefined amplitude threshold for a duration longer than a predefined duration threshold; and
removing the one or more silence time segments from the first vocal component and the second vocal component.

4. The computing system of claim 1, wherein:
the one or more processing devices are further configured to perform speaker diarization prior to extracting the one or more first embedding vectors and the one or more second embedding vectors; and
performing speaker diarization includes identifying a plurality of first singer-specific time segments included in the first vocal component and a plurality of second singer-specific time segments included in the second vocal component.

5. The computing system of claim 4, wherein the one or more processing devices are further configured to:
compute a respective plurality of similarity values between the first singer-specific time segments and the second singer-specific time segments;
for each of the similarity values, determine whether that similarity value is above the predefined similarity threshold; and
output the indication of whether the first music sample has the same singer as the second music sample based at least in part on the determinations of whether the similarity values are above the predefined similarity threshold.

6. The computing system of claim 4, wherein the one or more processing devices are configured to perform the speaker diarization at least in part using a speaker diarization ML model.

7. The computing system of claim 1, wherein the one or more processing devices are configured to compute the similarity value as a cosine similarity.

8. The computing system of claim 1, wherein the one or more processing devices are further configured to:
compute a plurality of first embedding vectors respectively associated with a plurality of first time segments included in the first vocal component;
compute a plurality of second embedding vectors respectively associated with a plurality of second time segments included in the second vocal component; and
compute the similarity value between a first embedding average of the first embedding vectors and a second embedding average of the second embedding vectors.

9. The computing system of claim 1, wherein the one or more processing devices are further configured to:
compute a plurality of first embedding vectors respectively associated with a plurality of first time segments included in the first vocal component;
compute a plurality of second embedding vectors respectively associated with a plurality of second time segments included in the second vocal component; and
compute the similarity value as a maximum similarity value among pairs of the first embedding vectors with the second embedding vectors.

10. The computing system of claim 1, wherein the one or more processing devices are further configured to:
compute a plurality of first embedding vectors respectively associated with a plurality of first time segments included in the first vocal component;
compute a plurality of second embedding vectors respectively associated with a plurality of second time segments included in the second vocal component; and
compute the similarity value as a weighted sum over respective pair similarity values computed for pairs of the first embedding vectors with the second embedding vectors.

11. The computing system of claim 1, wherein the music source separation ML model is a U-Net convolutional neural network (CNN).

12. The computing system of claim 1, wherein the voice embedding ML model is a recurrent neural network (RNN).

13. A method for use with a computing system, the method comprising:
receiving a first music sample and a second music sample;
at a music source separation machine learning (ML) model, extracting a first vocal component from the first music sample and a second vocal component from the second music sample;
at a voice embedding ML model, extracting one or more first embedding vectors from the first vocal component and one or more second embedding vectors from the second vocal component;
computing a similarity value between the one or more first embedding vectors and the one or more second embedding vectors;
determining whether the similarity value is above a predefined similarity threshold; and
based at least in part on the determination of whether the similarity value is above the predefined similarity threshold, outputting an indication of whether the first music sample has a same singer as the second music sample.

14. The method of claim 13, further comprising performing silence removal on the first vocal component and the second vocal component prior to extracting the one or more first embedding vectors and the one or more second embedding vectors.

15. The method of claim 14, wherein performing the silence removal includes:
identifying, in each of the first vocal component and the second vocal component, one or more silence time segments in which an amplitude is below a predefined amplitude threshold for a duration longer than a predefined duration threshold; and
removing the one or more silence time segments from the first vocal component and the second vocal component.

16. The method of claim 13, further comprising performing speaker diarization prior to extracting the one or more first embedding vectors and the one or more second embedding vectors, wherein performing speaker diarization includes identifying a plurality of first singer-specific time segments included in the first vocal component and a plurality of second singer-specific time segments included in the second vocal component.

17. The method of claim 16, further comprising:
computing a respective plurality of similarity values between the first singer-specific time segments and the second singer-specific time segments;
for each of the similarity values, determining whether that similarity value is above the predefined similarity threshold; and
outputting the indication of whether the first music sample has the same singer as the second music sample based at least in part on the determinations of whether the similarity values are above the predefined similarity threshold.

18. The method of claim 13, wherein the music source separation ML model is a U-Net convolutional neural network (CNN).

19. The method of claim 13, wherein the voice embedding ML model is a recurrent neural network (RNN).

20. A computing system comprising:
one or more processing devices configured to:
receive a first music sample and a second music sample;
at a music source separation machine learning (ML) model, extract a first vocal component from the first music sample and a second vocal component from the second music sample;
perform speaker diarization on the first vocal component and the second vocal component to thereby identify a plurality of first singer-specific time segments included in the first vocal component and a plurality of second singer-specific time segments included in the second vocal component;
at a voice embedding ML model:
for each of the first singer-specific time segments, extract a corresponding first embedding vector from the first vocal component; and
for each of the second singer-specific time segments, extract a corresponding second embedding vector from the second vocal component;
compute a respective plurality of similarity values between the first sets of singer-specific time segments and the second sets of singer-specific time segments;
for each of the similarity values, determine whether that similarity value is above the predefined similarity threshold; and
output the indication of whether the first music sample has the same singer as the second music sample based at least in part on the determinations of whether the similarity values are above the predefined similarity threshold.
